(19) United States
(12) Patent Application Publication
(10) Pub. No.: US 2023/0156508 A1
(43) Pub. Date: May 18, 2023

(54) METHODS AND DEVICES FOR MANAGING MEASUREMENT OF RADIO LINK QUALITY

(71) Applicant: ZTE CORPORATION, Shenzhen (CN)

(72) Inventors: Fei DONG, Shenzhen (CN); He HUANG, Shenzhen (CN); Mengzhu CHEN, Shenzhen (CN)

(73) Assignee: ZTE CORPORATION, Shenzhen (CN)

(21) Appl. No.: 18/093,945

(22) Filed: Jan. 6, 2023

Related U.S. Application Data
(63) Continuation of application No. PCT/CN2020/107528, filed on Aug. 6, 2020.

(51) Int. Cl. H04W 24/10; H04W 76/28; H04W 24/08

(52) U.S. Cl. CPC H04W 24/10; H04W 76/28; H04W 24/08

(57) ABSTRACT

This disclosure relates to methods and devices for managing measurement of quality of the radio link between the wireless network access node and the user equipment in a wireless communication system. In one implementation, the method may include obtaining, by a user equipment, an information on adjusting an indication period. The indication period may represent a time period during every which a radio link quality indication being sent to an upper layer of the user equipment. The radio link quality indication may indicate quality of a radio link between the user equipment and a wireless access network node. The method may further include determining, based on the information, whether to adjust the indication period.

### TECHNICAL FIELD

This disclosure is directed generally to wireless communications and particularly to manage measurement of radio link quality in a wireless communication network.

### BACKGROUND

In the existing wireless communication system, radio link failure (RLF) detection and recovery procedure is used to maintain the radio link between wireless network access node (WANN) and user equipment (UE). At the beam level, the beam failure detection (BFD) and beam failure recovery (BFR) is used to keep the suitable downlink (DL) beam. To perform RLF detection and beam failure detection, the UE is configured with reference signals. Generally, the WANN transmits the reference signal to the UE periodically and the UE has to measure the periodically transmitted reference signals to determine the quality of the radio link between the UE and the WANN, which inevitably consumes the power of the UE.

### SUMMARY

This disclosure is directed to methods, systems, and devices related to wireless communication, and more specifically, for managing measurement of quality of the radio link between the wireless network access node and the user equipment.

In one embodiment, a method for managing measurement of radio link quality by a user equipment is disclosed. The method may be performed at a user equipment. The method may include obtaining an information on adjusting an indication period. The indication period may represent a time period during every which a radio link quality indication is sent to an upper layer of the user equipment. The radio link quality indication may indicate quality of a radio link between the user equipment and a wireless access network node. The method may further include determining, based on the information, whether to adjust the indication period.

In another embodiment, a device for wireless communication may include a memory storing instructions and a processing circuitry in communication with the memory. When the processing circuitry executes the instructions, the processing circuitry is configured to carry out the above methods.

In another embodiment, a computer-readable medium comprising instructions which, when executed by a computer, cause the computer to carry out the above methods.

The above and other aspects and their implementations are described in greater detail in the drawings, the descriptions, and the claims below.

### BRIEF DESCRIPTION OF THE DRAWINGS

FIG. 1 illustrates an example system diagram including a user equipment and a wireless access network node in accordance with various embodiments.

FIG. 2 shows a flow diagram of a method for wireless communication in accordance with an embodiment.

FIG. 3 schematically illustrates radio link failure monitoring in the case of relaxed radio link quality measurement.

FIG. 4 schematically illustrates beam failure monitoring in the case of relaxed radio link quality measurement.

FIG. 5 shows a flow diagram of a method for wireless communication in accordance with an embodiment.

FIG. 6 schematically illustrates a discontinuous reception cycle.

### DETAILED DESCRIPTION

The technology and examples of implementations and/or embodiments in this disclosure can be used to improve performance in wireless communication systems. The term “exemplary” is used to mean “an example of” and unless otherwise stated, does not imply an ideal or preferred example, implementation, or embodiment. Section headers are used in the present disclosure to facilitate understanding and do not limit the disclosed technology in the sections only to the corresponding section. Please note that the implementations may, however, be embodied in a variety of different forms and, therefore, the covered or claimed subject matter is intended to be construed as not being limited to any of the embodiments to be set forth below. Please also note that the implementations may be embodied as methods, devices, components, or systems. Accordingly, embodiments of this disclosure may, for example, take the form of hardware, software, firmware or any combination thereof.

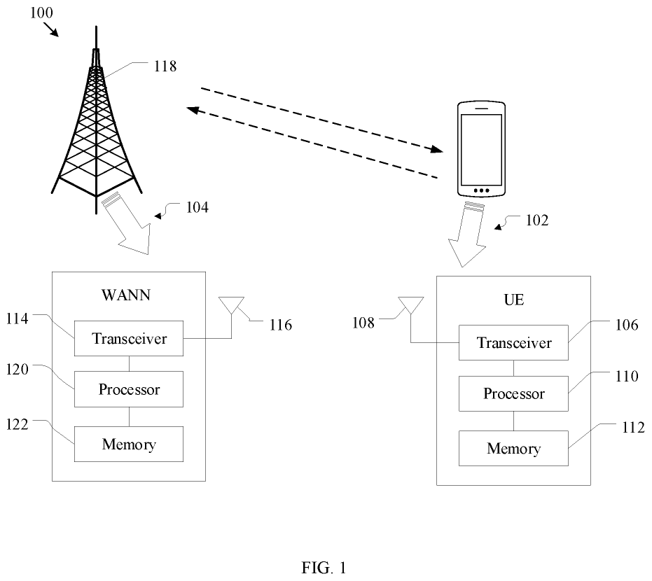

A wireless access network provides network connectivity between user equipment and an information or data network such as a voice or video communication network, the Internet, and the like. An example wireless access network may be based on cellular technologies, which may further be based on, for example, 4G, Long Term Evolution (LTE), 5G, and/or New Radio (NR) technologies and/or formats. FIG. 1 shows an example system diagram of wireless communication network 100 including a user equipment (UE) 102 and a wireless access network node (WANN) 104 according to various embodiments. The UE 102 may include but is not limited to a mobile phone, smart phone, tablet, laptop computer, a smart electronics or appliance including an air conditioner, a television, a refrigerator, an oven and the like, or other devices that are capable of communicating wirelessly over a network. The UE 102 may include transceiver circuitry 106 coupled to an antenna 108 to effect wireless communication with the wireless access network node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Similarly, the wireless access network node 104 may comprise a base station or other wireless network access points capable of communicating wirelessly over a network with one or more UEs. For example, the wireless access network node 104 may comprise a 5G new radio (NR) base station, a 5G central-unit base station, or a 5G distributed-unit base station, a 5G core station, or an application server in various embodiments. . Each type of these wireless access network nodes may be configured to perform a corresponding set of wireless network functions. The set of wireless network functions between different types of wireless access network nodes may not be identical. The set of wireless network functions between different types of wireless access network nodes, however, may functionally overlap. The wireless access node 104 may include transceiver circuitry 114 coupled to an antenna 116, which may include an antenna tower 118 in various approaches, to effect wireless communication with the UE 102. The transceiver circuitry 114 may also be coupled to one or more processors 120, which may also be coupled to a memory 122 or other storage device. The memory 122 may store therein instructions or code that, when read and executed by the processor 120, cause the processor 120 to implement various ones of the methods described herein.

For simplicity and clarity, only one WANN and one UE are shown in the wireless communication network 100. It will be appreciated that one or more WANNs may exist in the wireless communication network, and each WANN may serve one or more UEs in the meantime.

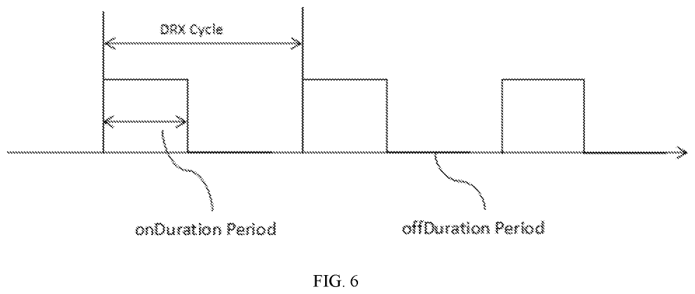

The evolving new generation wireless communication network provides discontinuous reception for user equipments. The discontinuous reception is a method used in wireless communication to conserve the battery of the user equipments. For example, a user equipment and the network may negotiate phases in which data transfer occurs. During other times the user equipment may turn its receiver off and enters a low power state. One of the objectives of the present disclosure is to dynamically adjust indication period, which may represent the time interval to measure quality of radio link between the UE and the WANN for RLF detection and beam failure detection in the case that the DRX is applied to the radio link between the UE and the WANN. With reference to FIG. 6, a DRX cycle may include an onDuration period and an offDuration period. The UE may monitor physical downlink control channel (PDCCH) in the onDuration period and may not have to monitor PDCCH in the offDuration period.

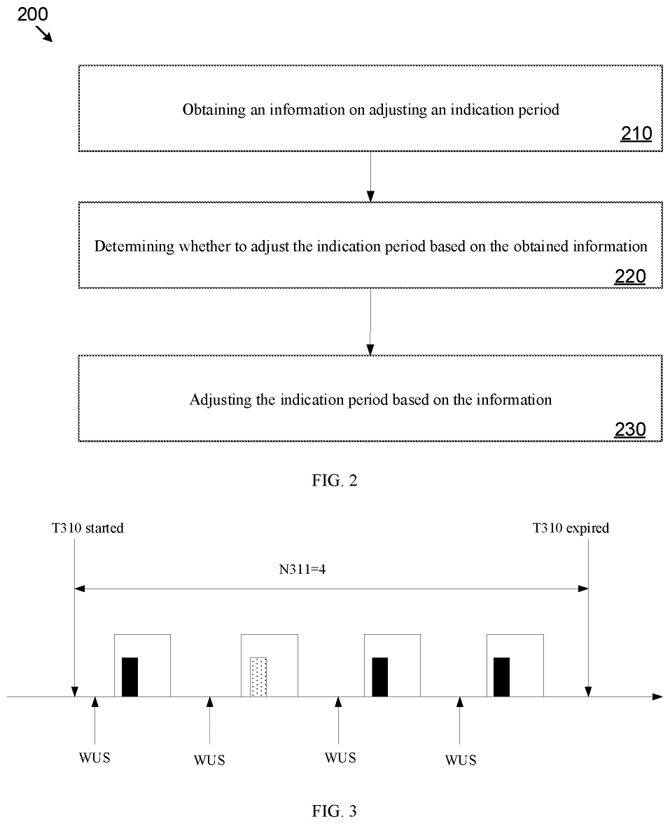

FIG. 2 illustrates an example implementation 200 of adjusting indication period. By way of example, various operations of a user equipment such as the UE 102 that adjusting the indication period will be described with reference to FIG. 1 and FIG. 2.

The UE 102 may obtain an information on adjusting an indication period (210). The indication period may represent a time period. During every such time period, a radio link quality indication may be sent to from a lower layer, such as a physical layer, to an upper layer, such as the MAC layer, of the UE 102. The radio link quality indication may indicate quality of a radio link between the user equipment and a wireless access network node. For example, the radio link quality indication may represent that an actual measurement result is higher or lower than a predetermined threshold. The actual measurement result may represent the result of measuring the quality of the radio link between the UE 102 and the WANN 118. The UE 102 may determine whether to adjust the indication period based on the obtained information (220). The adjustment of the indication period may extend or shorten the indication period. When the indication period is extended, the radio link quality measurement is relaxed.

In an implementation, the UE 102 may receive the information on adjusting the indication period from is the WANN 118. The information may include an indication whether to allow UE 102 to adjust the indication period. The WANN 118 may transmit the information via a radio resource control (RRC) signaling, a media access control (MAC) control element (CE) signaling, or a downlink control information (DCI) signaling. In the case that the MAC CE signaling is used, the MAC CE may include channel state information reference signal (CSI-RS) identifier (ID), Serving Cell ID, bandwidth part (BWP) ID, synchronization signal block (SSB) ID, offset parameter for adjusting the indication period which will be described later in detail, and indication of measurement mode to be used, e.g., relaxation or non-relaxation. In the case that the DCI signaling is used, the DCI may include codepoint representing the BWP ID, codepoint representing the serving cell ID, codepoint representing the CSI-RS, codepoint representing the SSB, codepoint representing offset parameter, codepoint representing indication of measurement mode to be used.

In an implementation, the UE 102 may receive the information on adjusting the indication period from the WANN 118. The information may include an indication whether to allow UE 102 to adjust the indication period. The WANN 118 may transmit the information via a radio resource control (RRC) signaling, a media access control (MAC) control element (CE) signaling, or a downlink control information (DCI) signaling. In an implementation, the combination of above mentioned information may be used (i.e., RRC, MAC CE, DCI). For example, offset parameter for adjusting the indication period is transmitted to the UE 102 from the WANN 118 via RRC signaling. Adjust indication is transmitted to the UE 102 from the WANN 118 via MAC CE or DCI signaling. In such case the MAC CE may include channel state information reference signal (CSI-RS) identifier (ID), Serving Cell ID, bandwidth part (BWP) ID, synchronization signal block (SSB) ID, and indication of measurement mode to be used, e.g., relaxation or non-relaxation. In the case that the DCI signaling is used, the DCI may include codepoint representing the BWP ID, codepoint representing the serving cell ID, codepoint representing the CSI-RS, codepoint representing the SSB, codepoint representing indication of measurement mode to be used.

In another implementation, the UE 102 may read the information on adjusting the indication period from a memory of the UE 102. The information may include a predetermined rule to determine whether to adjust the indication period based on a specified event. For example, the specified event may indicate reception of a wake up signal (WUS). Where the wake up signal does not indicate the UE 102 to wake up within the associated DRX cycle, the UE 102 may determine to extend the indication period. Where the wake up signal indicates the UE 102 to wake up the associated DRX cycle and the indication period has been adjusted to an extended indication period for relaxation measurement, the UE 102 may restore the indication period from the extended indication period. For example, the indication period may return to the original indication period prior to the adjustment. Alternatively, the indication period may return to a time period which is less than the extended indication period.

Additionally or alternatively, the specified event may include a measured metric of a reference signal, which may indicate the quality of the radio link between the UE 102 and the WANN 118. The measured metric of the reference signal may include, for example, a reference signal received power, a signal-to-interference-plus-noise ratio, and a path loss. Where the measured metric is greater than or equal to a predetermined threshold, the UE 102 may determine to extend the indication period. Where the measured metric is less than the predetermined threshold and the indication period has been adjusted to an extended indication period, the UE 102 may restore the indication period from the extended indication period. For example, the indication period may return to the original indication period prior to the adjustment. Alternatively, the indication period may return to a time period which is less than the extended indication period.

Additionally or alternatively, in the case that the UE 102 may be configured with a DRX for the radio link between the UE 102 and the WANN 118, the specified event may include a status of a monitoring timer related to monitoring the quality of the radio link. The monitoring timer may include, for example, a T310 timer and a beam failure detection timer, e.g., beamFailureDetectionTimer. The T310 timer may be used in the radio link failure (RLF) measurement. For example, the T310 timer may be started in the case that N310 consecutive out-sync indication is received and may be stopped in the case that N311 consecutive in-sync indication is received. When the T310 timer is expired, the RLF may be triggered. The beamFailureDetectionTimer may be used in BFR measurement. For example, the MAC entity of the UE 102 may be configured with beamFailureInstanceMaxCount and a beamFailureDetectionTimer for each serving cell including the WANN 118. In the case that the beam failure indication is received, the UE 102 may increase BFI_COUNTER by 1 and start or restart beamFailureDetectionTimer. Where the beamFailureDetectionTimer is expired, the UE 102 may set the BFI_COUNTER to zero. Where BFI_COUNTER reaches the maximum number beamFailureInstanceMaxCount, the UE 102 may trigger the BFR.

Where the status of the monitoring timer indicates the monitoring timer is stopped, the UE 102 may determine to extend the indication period. Where the status of the monitoring timer indicates the monitoring timer is running, the UE 102 may restore the indication period from the extended indication period. For example, the extended indication period may return to the original indication period prior to the adjustment. Alternatively, the indication period may return to a time period which is shorter than the extended indication period.

Additionally or alternatively, in the case that the UE 102 is configured with a DRX for the radio link between the UE 102 and the WANN 118, the specified event may include a status of the UE 102. Where the status of the UE 102 indicates the UE 102 is inactive, the UE 102 may determine to extend the indication period. Where the status of the UE 102 indicates the UE 102 is active, the UE 102 may restore the indication period from the extended indication period. For example, the indication period may return to the original indication period prior to the adjustment. Alternatively, the indication period may return to a time period which is shorter than the extended indication period.

Additionally or alternatively, in the case that the UE 102 is performing the relaxed measurement for BFR and RLF (i.e extended indication period is using), the UE 102 may determine whether some event for mobility is triggered. If so, the UE 102 may restore the indication period from the extend the indication period. The event may include at least one of the followings: (1) Event A2: serving becomes worse than threshold; (2) Event A3: neighbor cell becomes offset better than SpCell; (3) Event A4: neighbor cell becomes better than threshold; (4) Event A5: SpCell becomes worse than a threshold and neighbor cell becomes better than another threshold. (5) Event B1: Inter Radio access technology (RAT) neighbor cell becomes better than a threshold. (6) Event B2: PCell becomes worse than a threshold and inter RAT neighbor cell becomes better than another threshold. (7) Event I: interference becomes higher than threshold.

Additionally or alternatively, in the case that a serving cell covering the UE 102 is a dormancy serving cell or the active BWP at this serving cell is a dormancy BWP, the UE 102 will perform the relaxed measurement for the serving cell. In some implementations, the dormancy serving cell is the SCell or the dormancy BWP is a BWP where the UE 102 only performs measurement (CSI-RS or SSB) but does not monitor the PDCCH, the physical downlink shared channel (PDSCH) or transmission on uplink shared channel and PUCCH.

Referring to FIG. 2, where the UE 102 determines to adjust the indication period at step 220, the UE 102 may adjust the indication period based on the information obtained at step 210 (230). In an implementation, the information may include, for example, offset parameter for adjusting the indication period. For example, the offset parameter may be received from the WANN 118 via the MAC CE signaling or the DCI signaling or radio resource control signaling (RRC). For another example, the offset parameter may be configured to the UE 102 in a granularity of Cell group or Cell. For another example, the offset parameter maybe predefined, for example, in technical specification such as wireless communication protocol. The offset parameter may include, for example, a first coefficient of a DRX cycle, a second coefficient of a shortest period of receiving a reference signal for measuring the quality of the radio link from the WANN 118, a third coefficient of a longest period of receiving the reference signal from the WANN 118, and a period value with a specified time unit. The time unit may include, for example, millisecond, slot, symbol, and sub-frame, etc.

Where the offset parameter includes the first coefficient of a DRX cycle, the UE 102 may adjust the indication period to be equal to a maximum value between a shortest period of the reference signal and the DRX cycle multiplying the first coefficient. Additionally or alternatively, where the offset parameter includes the second coefficient of a shortest period of receiving a reference signal from the WANN 118, the UE 102 may adjust the indication period to be equal to a maximum value between the DRX cycle and the shortest period of the reference signal multiplying the second coefficient. Additionally or alternatively, where the offset parameter includes a third coefficient of a longest period of receiving the reference signal from the WANN 118, the UE 102 may adjust the indication period to be equal to a maximum value between the DRX cycle and the longest period of the reference signal multiplying the third coefficient. Additionally or alternatively, where the offset parameter includes the period value, the UE 102 may adjust the indication period to be equal to a maximum value among the shortest period of the reference signal, the DRX cycle, and the period value. The first coefficient, the second coefficient, the third coefficient, and the period value may be either predefined, for example, in technical specification such as a wireless communication protocol or dynamically received from the WANN 118, for example, via a RRC signaling, a DCI signaling, or a MAC CE signaling.

Where the indication period is extended, the UE 102 may decrease the frequency to measure the radio link quality. The relaxation of radio link quality measurement may undesirably impact the UE 102 to perform radio link failure detection using T310 timer and beam failure detection using beamFailureDetectionTimer. FIG. 3 illustrates a radio link failure monitoring in the case of relaxation measurement. As illustrated, during the time period of running the T310 timer, the UE 102 may expect to obtain four consecutive in-sync indication. Otherwise, the UE 102 may trigger the radio link failure. However, due to the relaxed measurement, the UE 102 fails to perform sufficient times of radio link quality measurement within the time period running the T310 timer which leads to produce less than four consecutive in-sync indication. For example, the UE 102 may obtain only three consecutive in-sync indications during the running of the T310 timer. As a result, although the radio link may work well with good quality, the UE 102 may trigger a false radio link failure.

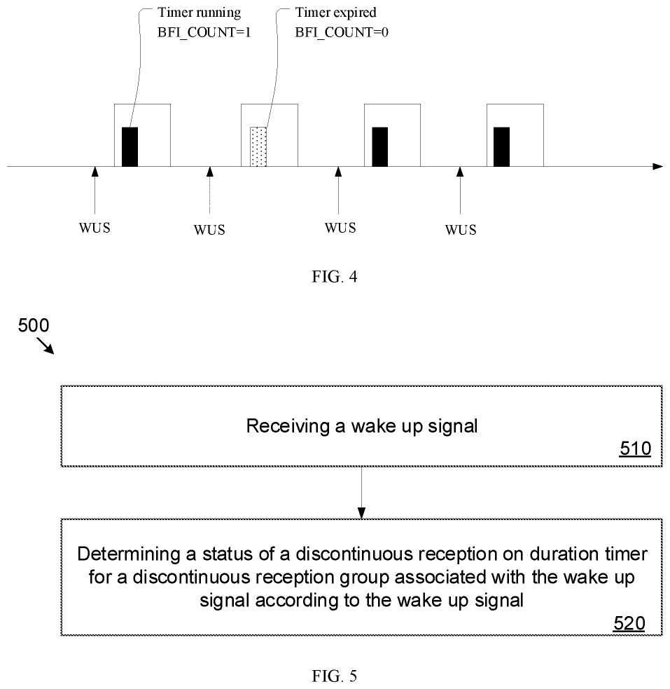

FIG. 4 illustrates a beam failure monitoring in the case of relaxation measurement. In the case that the beam failure indication is received, the UE 102 may increase BFI_COUNTER by 1 and start or restart beamFailureDetectionTimer. Where the beamFailureDetectionTimer is expired, the UE 102 may set the BFI_COUNTER to zero. Where BFI_COUNTER reaches the maximum number beamFailureInstanceMaxCount, the UE 102 may trigger the beam failure. However, the relaxed measurement may render sparse beam failure indications during running of the beamFailureDetectionTimer. The expiration of the beamFailureDetectionTimer resets the BFI_COUNTER. Therefore, BFI_COUNTER can hardly reach the beamFailureInstanceMaxCount to trigger the beam failure even if the beam failure occurs.

To address the negative impact on radio link failure detection and beam failure detection by relaxed measurement, the UE 102 may be configured with a mechanism to suspend the T310 timer and beamFailureDetectionTimer in the case that the indication period for RLF measurement and BFD is used. Alternatively, the UE 102 may be configured with two monitoring timers, e.g., two T310 timer or two beamFailureDetectionTimer. The two sets of monitor timers may be respectively used in relaxed measurement (i.e using original indication period) and unrelaxed measurement. (i.e using extended indication period)

For example, the UE 102 may make use of a first monitoring timer when the original indication period is used, i.e., non-relaxation of measurement. The UE 102 may make use of a second monitor timer when the expended indication period is used, i.e., relaxation of measurement. The WANN 118 may configure the second monitor timer and transmit to the UE 102, for example, via RRC signaling.

In the event that the UE 102 starts to measure radio link quality per the extended indication period while the first monitoring timer is running, the UE 102 may stop the first monitoring timer and switch to use the second monitoring timer in monitoring the quality of the radio link.

Moreover, when the UE 102 determines to terminates measuring the quality of the radio link per the extended indication period and restore to measure the quality of the radio link per the original indication period, the UE 102 may restart the first monitoring timer. In the meantime, the UE 102 may stop using the second monitoring timer and switch back to use the first monitoring timer.

A DRX group may include a set of DRX configuration parameters. A user equipment such as the UE 102 may maintain multiple DRX groups which may be used by different cells serving the UE 102. It is likely that multiple cells serving the UE 102 may use the same DRX group. Due to the maintenance of multiple DRX groups, the UE 102 may have to determine which DRX group(s) the wake up signal may apply. In an implementation, the WUS signal is used for indicating whether the drx-ondurationTimer is started for the current DRX cycle. FIG. 5 illustrates an example implementation 500 of applying wake up signal for a DRX group. By way of example, various operations of the UE 102 that applies wake up signal for the DRX group will be described with reference to FIG. 1 and FIG. 5.

The UE 102 may receive a WUS signal, for example, from the WANN 118 (510). The WUS signal may be a downlink control indication (DCI). The index of applicable DRX group that can be applied the WUS may be indicated in the DCI. For example, the applicable DRX Group of the UE 102 may be indicated by the codepoints of the DCI. One codepoint may represent one DRX group. The value ‘0’ of the codepoint may represent that the drx-ondurationTimer for this DRX group will not start for the corresponding DRX cycle , and the value ‘1’ of such code point may represent that the drx-ondurationTimer for this DRX group will start for the corresponding DRX cycle.

Additionally or alternatively, the WUS signal may be a MAC CE which may indicate the applicable DRX group. For example, the MAC CE may include DRX group identifiers, the indication of drx-ondurationTimer status for each DRX group, and the indication of number of periods DRX group.

Additionally or alternatively, the WUS signal may be only applicable to the primary DRX group among the DRX groups. The DRX group may be defined as primary DRX group if it is used by a primary cell such as SpCell. Additionally or alternatively, the UE 102 may determine the primary DRX group from the indication in RRC signaling, for example, transmitted from the WANN 118.

Then, the UE 102 may determine a status of the DRX on duration timer, e.g., drx-ondurationTimer status for the applicable DRX group according to the WUS signal (520). In an implementation, where the WUS signal contain the identification of the DRX group that may apply the WUS signal as discussed above, the UE 102 may determine the applicable DRX group according to the WUS signal. In this case, where the WUS signal is not received because of the bandwidth part (BWP) switch, there is measurement gap, or the WUS occasion is within the UE active status, the UE 102 may start the drx-ondurationTimer of all the applicable DRX groups after the drx-slotoffset for the corresponding cycle. If WUS signal is not received from lower layer and ps-wakeup is configured for one or more DRX groups, the UE 102 may start the on duration timer of the applicable DRX groups configured with ps-wakeup after the drx-slotoffset for the corresponding cycle.

In another implementation, the UE 102 may determine that the WUS signal is only applicable to the DRX group that is used by the cell where the WUS signal is received. In an implementation, a primary cell may be configured for each DRX group, the WUS signal may be sent on the primary cell of each DRX group. In another implementation, the WUS signal may be sent on any cells of each DRX group. In the implementation, if WUS signal is not received because of the BWP switch, measurement gap in a DRX group, or the WUS occasion being within the UE active status in a DRX group, the UE 102 may start the drx-ondurationTimer of this DRX group after the drx-slotoffset for the corresponding cycle. If the WUS signal is not received from lower layer in a DRX group and ps-wakeup is configured for the DRX group, the UE 102 may start the on duration timer of the DRX group configured with ps-wakeup after the drx-slotoffset for the corresponding cycle.

With respect to the ps-wakeup, the ps-wakeup may be configured per DRX group, and ps-wakeup is only available for the DRX group where it is configured. Additionally or alternatively, the ps-wakeup is configured on primary DRX group, and ps-wakeup is available for all DRX groups.

Here, the channel state information (CSI) reporting for the DRX group will be described. In an implementation, the UE 102 determines if it is in active status for a DRX group. If the UE 102 is not in active status, the UE 102 may determine the reason why it is not in active status. If the reason is that the received WUS signal indicates the drx-ondrationTimer is not started, the UE 102 may determine whether the information element ps-TransmitOtherPeriodicCSI is configured for this DRX group. If the ps-TransmitOtherPeriodicCSI is configured for this DRX group, the UE 102 may report measurement result of CSI, other than reference signal receive power (RSRP) CSI, via physical uplink control channel (PUCCH). The UE 102 may further determine whether the information element ps-TransmitPeriodicLl-RSRP is configured for this DRX group. If the ps-TransmitPeriodicLl-RSRP is configured for this DRX group, the UE 102 may report the measurement result of RSRP CSI via PUCCH.

The WUS signal may include parameters to configure ps-TransmitOtherPeriodicCSI and ps-TransmitPeriodicLl-RSRP on different DRX configuration to the UE 102. In an implementation, parameters of the WUS signal may be configured separately for different DRX configurations. In another implementation, parameters of the WUS signal in primary DRX configuration shall be applied to all DRX groups.

Moreover, in the case that one DRX group of the UE 102 is activated while another DRX group of the UE 102 is deactivated, it is likely that the UE 102 may be configured to measure the CSI in the one DRX group while reporting the CSI in the another DRX group. In this case, the UE 102 may take the status of DRX group where the CSI measurement is performed as the status of the UE 102. Alternatively, the UE 102 may take the status of DRX group where the CSI reporting is performed as the status of the UE 102. Alternatively, the UE 102 may take the status of the primary DRX group as the status of the UE 102.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a user equipment for wireless communication, comprising:
obtaining an information on adjusting an indication period, the indication period representing a time period during every which a radio link quality indication being sent to an upper layer of the user equipment, the radio link quality indication indicating quality of a radio link between the user equipment and a wireless access network node; and
determining, based on the information, whether to adjust the indication period.

2. The method of claim 1, further comprising:
in response to determining to adjust the indication period, adjusting the indication period based on the information.

3. The method of claim 2, wherein the information comprises an offset parameter for adjusting the indication period, the adjusting the indication period comprises:
adjusting the indication period based on the offset parameter, wherein the offset parameter comprises at least one of:
a first coefficient of a discontinuous reception cycle,
a second coefficient of a shortest period of receiving a reference signal from the wireless access network node, the reference signal being for measuring the quality of the radio link,
a third coefficient of a longest period of receiving the reference signal from the wireless access network node, or
a period value with a specified time unit.

4. The method of claim 3, wherein the offset parameter comprises the first coefficient, the adjusting the indication period comprises:
adjusting the indication period to be equal to a maximum value between a shortest period of the reference signal and the discontinuous reception cycle multiplying the first coefficient.

5. The method of claim 3, wherein the offset parameter comprises the second coefficient, the adjusting the indication period comprises:
adjusting the indication period to be equal to a maximum value between the discontinuous reception cycle and the shortest period of the reference signal multiplying the second coefficient.

6. The method of claim 3, wherein the offset parameter comprises the third coefficient, the adjusting the indication period comprises:
adjusting the indication period to be equal to a maximum value between the discontinuous reception cycle and the longest period of the reference signal multiplying the third coefficient.

7. The method of claim 3, wherein the offset parameter comprises the period value, the adjusting the indication period comprises:
adjusting the indication period to be equal to a maximum value among the shortest period of the reference signal, the discontinuous reception cycle, and the period value.

8. The method of claim 3, wherein the offset parameter is received from the wireless access network node.

9. The method of claim 8, wherein the offset parameter is received via a radio resource control (RRC) signaling, a downlink control information (DCI) signaling, or a media access control (MAC) control element (CE) signaling.

10. The method of claim 1, wherein the information comprises a predetermined rule to determine whether to adjust the indication period based on a specified event.

11. The method of claim 10, wherein the user equipment is configured with a discontinuous reception and the specified event indicates a status of a monitoring timer related to monitoring the quality of the radio link, the determining whether to adjust the indication period comprises:
in response to the status of the monitor timer being stopped, determining to adjust the indication period to an extended indication period.

12. The method of claim 11, further comprising:
in response to the status of the monitor timer being running, restoring the indication period from the adjusted indication period.

13. The method of claim 11, wherein the monitoring timer comprises a T310 timer or a beam failure detection timer.

14. The method of claim 10. wherein the specified event indicates reception of an adjust indication indicating to adjust the indication period, the determining whether to adjust the indication period comprises:
in response to reception of the adjust indication, determining to adjust the indication period.

15. The method of claim 14, wherein the adjust indication indicating to use an original indication period or restore to the original indication period from the adjusted indication period, the method further comprises:
adjusting the indication period to be equal to the original indication period.

16. The method of any of claim 1, further comprising:
in response to a triggering of measuring the quality of the radio link according to the adjusted indication period and a first monitoring timer related to monitoring the quality of the radio link being running,
stopping the first monitoring timer, the first monitoring timer adapting to be used when an original indication period being used, and
switching to use a second monitoring timer related to monitoring the quality of the radio link, the second monitoring timer adapting to be used when the adjusted indication period being used.

17. The method of claim 16, further comprising:
in response to a termination of measuring the quality of the radio link according to the adjusted indication period and the first monitoring timer being stopped, restarting the first monitoring timer.

18. The method of claim 16, further comprising:
in response to a termination of measuring the quality of the radio link according to the adjusted indication period and the second monitoring timer being used, switching back to use the first monitoring timer.

19. The method of claim 16, wherein the second monitoring timer is configured to the user equipment via a radio resource control signaling.

20. The method of claim 1, wherein the determining whether to adjust the indication period comprises:
determining, based on the information, whether to extend the indication period.

21. (canceled)

22. (canceled)
